(19) United States
(12) Patent Application Publication
(10) Pub. No.: US 2009/0254421 A1
(43) Pub. Date: Oct. 8, 2009

(54) Method of Matching Potential Clients to Legal Service Providers

(75) Inventor: Curtis Wolfe, Miami, FL (US)

Correspondence Address: HOWARD & HOWARD ATTORNEYS PLLC, 450 West Fourth Street, Royal Oak, MI, 48067, US

(73) Assignee: WCIS MEDIA LLC, Boca Raton, FL (US)

(21) Appl. No.: 12/417,979

(22) Filed: Apr. 3, 2009

Related U.S. Application Data
(60) Provisional application No. 61/042,450, filed on Apr. 4, 2008.

(51) Int. Cl. G06Q 99/00; G06Q 30/00

(52) U.S. Cl. 705/10; 705/14

(57) ABSTRACT

A method of matching potential customers to attorneys utilizes a computerized system that functions over the Internet. Records corresponding to the attorneys and categories in which the attorneys practice are stored in a database. A series of questions regarding a legal claim are presented to the potential customer via a web browser. The potential customer answers a series of “yes” or “no” questions to determine if they may have a valid legal claim. If it does appear they have a valid claim, the potential customer is assigned one or more categories. The customer is then presented an advertisement for one or more attorneys that practice in the category that matches the assigned category for the customer.

### CROSS REFERENCE TO RELATED APPLICATION

This application claims the benefit of provisional patent application No. 61/042,450 filed Apr. 4, 2008, which is hereby incorporated by reference.

### BACKGROUND OF THE INVENTION

1. Field of the Invention

The subject invention relates to computerized systems and methods for matching potential customers (i.e., clients) to service providers.

2. Description of the Related Art

Traditionally, attorneys and other professional service providers have eschewed advertising as a business promotion technique. Instead, these service providers have relied on word-of-mouth referrals in order to obtain customers (commonly referred to as “clients”). Thus, many attorneys spend an inordinate amount of time involved in network cultivation efforts in order to grow and expand their business.

Recently, with the widespread proliferation of computers and network connectivity, computerized systems and methods have been introduced for matching potential clients to attorneys. However, these computerized approaches are often just high-tech referral techniques.

One example of such a computerized referral approach is disclosed in U.S. Pat. No. 6,470,338 (The '338 patent). This disclosure details a method in which information regarding the legal matter is provided by a potential client. This information is then forwarded on to one or more attorneys who could then contact the client. However, the method of the '338 patent may not be suitable for a great number of potential clients who would rather initiate contact with one or more suitable attorneys.

Therefore, there remains an opportunity to provide a system and method for matching legal service providers with potential customers that allows the potential customer to decide and control initial contact with an attorney while allowing the attorney to market their specialty to a target audience.

### SUMMARY OF THE INVENTION AND ADVANTAGES

The subject invention discloses a method of matching potential customers to legal service providers. The method includes storing records corresponding to a plurality of legal service providers and a plurality of legal service categories in a computerized database. Each legal service provider is associated with at least one legal service category. A series of questions regarding a legal claim are presented to a potential customer via a computerized network. The method also includes receiving answers to the questions input by the potential customer. The potential customer is categorized into at least one of the plurality of categories based on the answers to the questions. The potential customer is then matched to at least one legal service provider based on corresponding legal service categories. The method also includes displaying at least one advertisement to the potential customer for at least one of the plurality of legal service providers matched to the potential customer.

By displaying the advertisement to the potential customer, the potential customer retains control over whether to follow through and initiate contact with the legal service provider. This allows the potential customer to “shop around” and find which legal service provider(s) meet their needs and that they feel comfortable working with.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is schematic block diagram of a computerized system that may be utilized with the subject invention;

FIG. 2 is a computer screen image of a first question presented to a potential customer that is answerable with a “yes” or a “no”;

FIG. 3 is a computer screen image of a second question presented to the potential customer in response to the answer given to the first question;

FIG. 4 is a computer screen image of a third question presented to the potential customer in response to the answer given to the second question;

FIG. 5 is a computer screen image showing legal service providers with capabilities that meet the needs of the potential customer based on the answers given to the questions; and

FIG. 6 is a computer screen image showing advertising activity for one of the legal service providers.

### DETAILED DESCRIPTION OF THE INVENTION

Referring to the Figures, wherein like numerals indicate corresponding parts throughout the several views, a method of matching potential customers to legal service providers is described herein. The potential customers are commonly referred to as “clients”. The legal service providers are typically licensed, practicing attorneys or a firm of multiple attorneys. However, other legal service providers, such as, but not limited to, paralegals and patent agents. Furthermore, other service providers outside of the legal field may also be served by the system and method of the subject invention. However, for purposes of clarity and simplicity, the term “potential customers” and “legal service providers” will primarily be used hereafter.

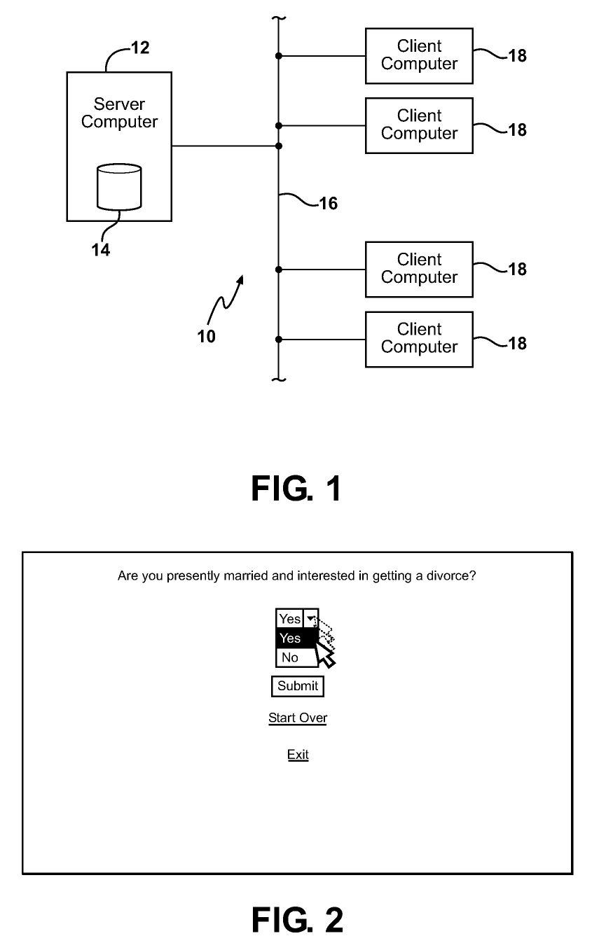

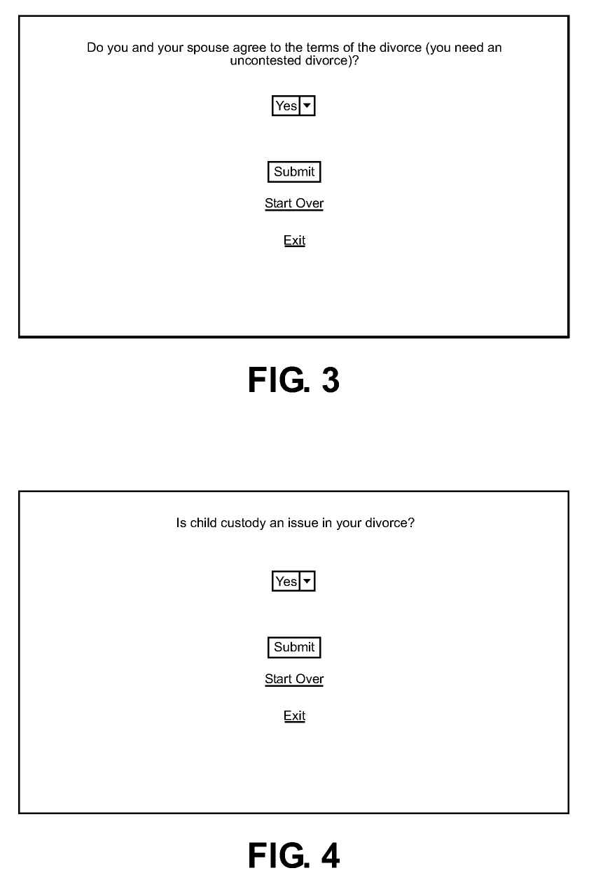

The method preferably operates in conjunction with a computerized system 10, as shown in FIG. 1. The system 10 includes a server computer 12 in communication with a database 14. The server computer 12 executes at least one computer program to facilitate the method described herein. The database 14 is preferably a relational database as is well known to those skilled in the art for storing records containing various data and other information. Examples of suitable databases 14 include, but are not limited to, MySQL, Oracle, and Microsoft Access.

The server computer 12 is in communication with a computerized network 16. Preferably, the computerized network 16 is the world-wide network known as the Internet. However, other implementations of the computerized network 16 are known to those skilled in the art. For instance, the computerized network 16 may be a cellular telephone network or a local area network (LAN).

The server computer 12 preferably includes a web server (not shown) for distributing web pages and other associated instructions that may be read via a web browser (e.g., Microsoft Internet Explorer, Firefox, etc.) or other client-side application. As such, potential customers and legal service providers may interact with the system 10 via a client computer 18 that is in communication with the computerized network 16. Of course, any number of client computers 18 may send and receive data from the server computer 12 via the network 16.

Although FIG. 1 shows a single server computer 12 with an integrated database 14, those skilled in the art realize that distributed models, where several computers and databases are utilized, may alternatively be implemented. Multiple web servers may also be implemented. Furthermore, the server computers 12, databases 14, and web servers need not share the same physical location.

The computerized method includes storing records corresponding to a plurality of legal service providers and a plurality of legal service categories in the computerized database 14. The legal services categories are preferably classifications of specialties of the law profession. These legal services categories may be broadly or narrowly defined. For example, broadly defined categories might include “divorce law” or “patent law,” while narrowly defined categories could include “divorce with child support and custody issues,” “divorce with no children,” “patent application preparation,” or “patent litigation.”

Each legal service provider is associated with at least one legal service category. That is, each attorney may associate himself or herself with one or more categories in which they practice based on experience, desire, or other factors. The database 14 provides a link (or relation) between each legal service provider and at least one legal service category.

As stated above, the potential customer may communicate with the system 10 via one of the client computers 18. In one embodiment, the potential customer accesses the system 10 via the Internet browser running on the client computer 18. The server computer 12 sends data to the potential customer in the form of an Internet web page displayed on the client computer 18. The web page displayed on the client computer 18 also accepts input from the potential customer that is thereby transmitted back to the server computer 12.

In a preferred embodiment, a potential customer accessing the web page is given the option to browse information on one or more legal topics. These legal topics may be generally associated with the broadly defined categories. The legal topics may include, but are not limited to: Accidents, Products Liability, Discrimination, Financial, Health Care, Employment, Family Law, Miscellaneous, Criminal, and/or Nursing Homes. The information on the legal topics is useful to give background information to the potential customer regarding the particular area of law including potentially what claims can be filed.

The method continues with the step of presenting a series of questions regarding a legal claim to the potential customer. This step is preferably presented after the potential customer has reviewed the information on at least one of the legal topics. However, this order is not a necessity, nor is the requirement that the potential customer review any information on any legal topic. The series of questions is presented to the potential customer via the computerized network 16. In the preferred embodiment, the questions are presented on the Internet browser running on the client computer 18.

The method continues with the step of receiving answers to the questions input by the potential customer. In the preferred embodiment, the potential customer answers the questions using the Internet browser. These answers are then sent to the server computer 12 via the computerized network 16.

Preferably, the presentation of questions progresses based on responses to the questions. After the answer to each question has been received, the server computer 12 determines whether to (a) present another question or (b) stop presenting questions. Furthermore, each presented question (after the first question) is predicated on the response to the prior question.

The series of questions may be referred to as a first question, a second question, a third question, and so on. As such, the method of the preferred embodiment includes the steps of presenting the first question to the potential customer via a computerized network, determining the second question based on the answer to the first question, and presenting a second question to the potential customer via the computerized network.

It is also preferred that the questions presented to the potential customer are answerable with either a “yes” or a “no”. It is more preferable that the questions are answerable exclusively with either a “yes” or a “no”. Restricting the potential customer to a “yes” or “no” question aids in the process by limiting the amount of effort required by the potential customer and providing an unambiguous answer on which further decisions can be made by the computer program. Of course, in other embodiments, the questions may be answerable with a more elaborate response by the potential customer.

The method continues with the step of categorizing the potential customer into at least one of the plurality of categories based on the answers to the questions. That is, each potential customer is assigned one or more category of legal services that correspond to the answers given to the questions presented. The method also includes the step of matching the potential customer to at least one legal service provider based on corresponding legal service categories. As a result, each potential customer is matched to one or more attorneys that handle the type of legal matter that corresponds to the potential customer's legal issue. Categorizing and matching the potential customer is preferably performed by the computer program running on the server computer 12 in conjunction with the data stored in the database 14.

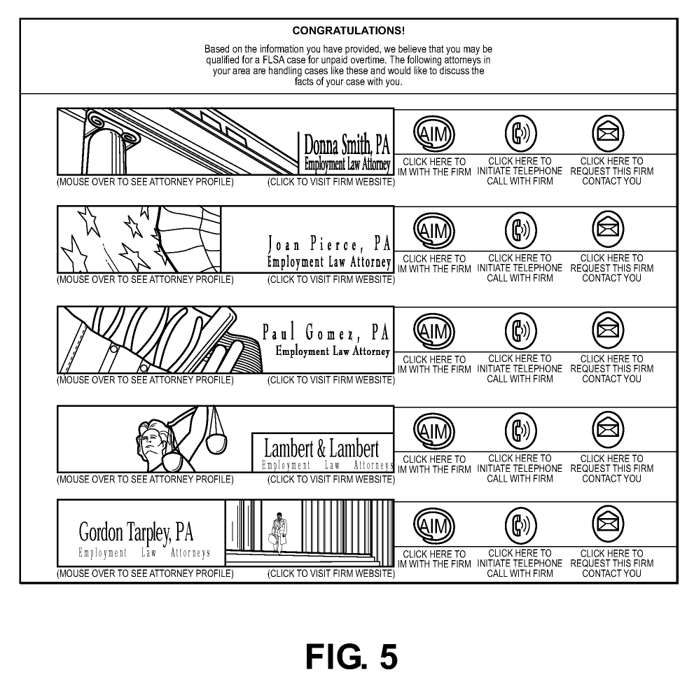

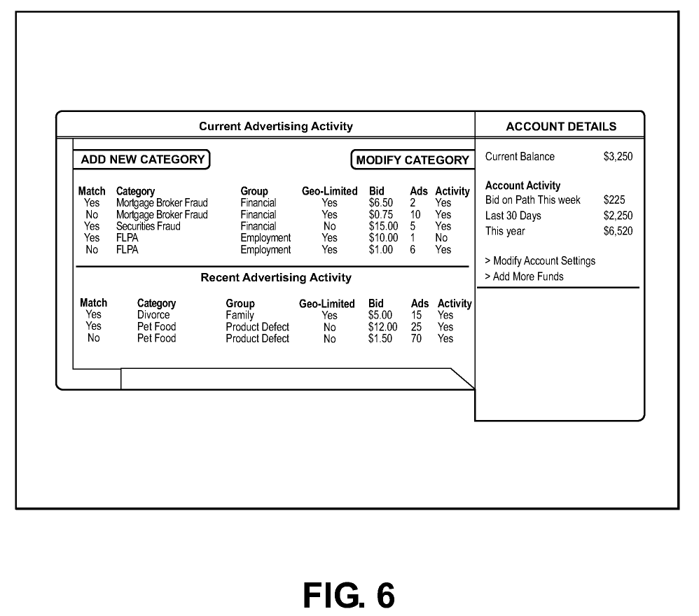

The method further includes the step of displaying an advertisement to the potential customer for at least one of the plurality of legal service providers matched to the potential customer. In the preferred embodiment, as shown in FIG. 5, the potential customer is shown multiple advertisements for attorneys that may be able to assist the client with their legal issue. Each advertisement may include contact information for the legal service provider. Each advertisement may also include one or more hyperlinks to the contact the legal service provider. For instance, one hyperlink may direct the potential customer to the legal service provider's web page, another hyperlink may initiate an email to the legal service provider, and yet another hyperlink may start an instant messaging (IM) application to contact the legal service provider.

The method may also include the step of receiving a geographical location of the potential customer. By knowing this geographical location, the server computer 12 may determine which legal service providers are in proximity to the potential customer. Thus, matching the potential customer to at least one legal service provider may be based on both corresponding legal service categories and geographical location of the potential customer. The geographical location may be acquired by the IP address of the potential customer, by the client entering information (e.g., ZIP code, street address, etc.), or other techniques known to those skilled in the art.

The advertisements displayed to the potential customer are typically purchased by the legal service provider. When a plurality of advertisements is displayed, these advertisements may be prioritized. That is, the order in which the advertisements are displayed and/or the relative size of each advertisement is based on some criteria. For example, the advertisement having the highest priority would typically be displayed at the top of the list and/or may have a larger size than the other advertisements. In one embodiment, the prioritization of the advertisements for the legal services is based on an amount paid for display of the advertisement. In other embodiments, the prioritization may be based on geographic proximity of the potential customer to the legal service provider or a combination of amount paid and geographic proximity. Those skilled in the art will realize other techniques for prioritizing the display of advertisements.

Legal service providers may submit bids for display of advertisements to prospective clients. That is, the legal service providers decide how much they would like to pay for their advertisement being shown in relation to specific categories. As such, the method includes the step of receiving bids for display of the advertisement associated with the legal service provide in at least one category. Accordingly, the legal service provider with the highest bid is awarded the highest priority for display of the advertisement.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of matching potential customers to legal service providers, said method comprising the steps of:
storing records corresponding to a plurality of legal service providers and a plurality of legal service categories in a computerized database wherein each legal service provider is associated with at least one legal service category;
presenting a series of questions regarding a legal claim to a potential customer via a computerized network;
receiving answers to the questions input by the potential customer;
categorizing the potential customer into at least one of the plurality of categories based on the answers to the questions;
matching the potential customer to at least one legal service provider based on corresponding legal service categories; and
displaying at least one advertisement to the potential customer for at least one of the plurality of legal service providers matched to the potential customer.

2. A method as set forth in claim 1 wherein the series of questions are answerable with either a “yes” or a “no”.

3. A method as set forth in claim 1 wherein the series of questions are answerable exclusively with either a “yes” or a “no”.

4. A method as set forth in claim 1 wherein said step of presenting a series of questions to a potential customer via a computerized network is further defined as the step of presenting a first question to the potential customer via a computerized network.

5. A method as set forth in claim 4 further comprising the step of determining a second question based on the answer to the first question.

6. A method as set forth in claim 5 further comprising the step of presenting the second question to the potential customer via the computerized network.

7. A method as set forth in claim 1 further comprising the step of receiving a geographical location of the potential customer.

8. A method as set forth in claim 7 wherein said step of matching the potential customer to at least one legal service provider is further defined as matching the potential customer to at least one legal service provider based on corresponding legal service categories and geographical location of the potential customer.

9. A method as set forth in claim 1 further comprising the step of prioritizing the plurality of legal service providers matched to the potential customer based on an amount paid for display of the advertisement.

10. A method as set forth in claim 9 wherein said step of displaying at least one advertisement to the potential customer is further defined as displaying at least one advertisement to the potential customers prioritized based on the amount paid for display of the advertisement by the legal service providers matched to the potential customer.

11. A method as set forth in claim 1 further comprising the step of receiving at least one bid for display of the advertisement associated with the legal service provider in at least one category.

12. A method as set forth in claim 11 further comprising the step of prioritizing the plurality of legal services matched to the potential customer based on the bids received for display of the advertisement.

13. A method as set forth in claim 1 further comprising the step of presenting a hyperlink associated with each legal service to the potential customer for contacting the legal service provider.

14. A computer program product for automatically matching potential customers to legal service providers, said computer program product comprising:
computer readable program code means for storing records corresponding to a plurality of legal service providers and a plurality of legal service categories in a database wherein each legal service provider is associated with at least one legal service category;
computer readable program code means for presenting a series of questions regarding a legal claim to a potential customer via a network;
computer readable program code means for receiving answers to the questions input by the potential customer;
computer readable program code means for automatically categorizing the potential customer into at least one of the plurality of categories based on the answers to the questions;
computer readable program code means for automatically matching the potential customer to at least one legal service provider based on corresponding legal service categories; and
computer readable program code means for displaying an advertisement to the potential customer for at least one of the plurality of legal service providers matched to the potential customer.
